(19) United States
(12) Patent Application Publication
(10) Pub. No.: US 2014/0220439 A1
(43) Pub. Date: Aug. 7, 2014

(54) COMPOSITE PROTECTIVE LAYER FOR LITHIUM METAL ANODE AND METHOD OF MAKING THE SAME

(71) Applicants: Michael Edward Badding, Campbell, NY (US); Lin He, Horseheads, NY (US); Lezhi Huang, Changsha City (CN); Yu Liu, Shanghai (CN); Zhaoyln Wen, Shanghai (CN); Meifen Wu, Shanghai (CN)

(72) Inventors: Michael Edward Badding, Campbell, NY (US); Lin He, Horseheads, NY (US); Lezhi Huang, Changsha City (CN); Yu Liu, Shanghai (CN); Zhaoyln Wen, Shanghai (CN); Meifen Wu, Shanghai (CN)

(21) Appl. No.: 14/131,296

(22) PCT Filed: Jun. 14, 2012
(86) PCT No.: PCT/US2012/042340

§ 371 Date: Apr. 10, 2014

(30) Foreign Application Priority Data
Jul. 12, 2011 (CN) 201110194785.7X

(51) Int. Cl. H01M 4/62; H01M 4/1395; H01M 4/04

(52) U.S. Cl. CPC H01M 4/628; H01M 4/0402; H01M 4/1395; H01M 2004/027
USPC 429/216; 427/126.1; 205/229

(57) ABSTRACT

The present disclosure relates to protected metal anode architecture and method of making the same, providing a protected metal anode architecture comprising a metal anode; and a composite protection film formed over and in direct contact with the metal anode, wherein the metal anode comprises a metal selected from the group consisting of an alkaline metal and an alkaline earth metal, and the composite protection film comprises particles of an inorganic compound dispersed throughout a matrix of an organic compound. The present disclosure also provides a method of forming a protected metal anode architecture.

### CROSS-REFERENCE TO RELATED APPLICATIONS

This application claims the benefit of priority under 35 U.S.C. §119 of Chinese Patent Application Serial No. CN201110194785.7 filed on Jul. 12, 2011 the content of which is relied upon and incorporated herein by reference in its entirety.

### TECHNICAL FIELD

The present disclosure relates to the field of electrochemical cells, relating to a protected metal anode architecture and a method of making the same. In particular, the present disclosure relates to a method of preparing inorganic and organic composite modified cell metal electrodes, wherein a composite protection layer can be formed on a surface of a metal electrode by composite modification. The present disclosure describes the reaction of metallic Li and pyrrole to form a lithiated pyrrole organic protective film on the Li surface, and meanwhile, metallic Li reduces metallic Al ions to form another inorganic protective layer of Li—Al alloy, where both layers are competing and reacting to form a composite protective layer.

### BACKGROUND

Recently, as various multi-functional portable electronic devices, such as cameras, mobile phones, laptops, etc., become smaller and lighter, the research on batteries used in these electronic devices is also promoted. Reversible secondary batteries, due to their many advantages such as high open circuit voltage, large energy density, and without pollution or memory effect (H. Ikeda, T. Saito, H. Tamura, in: A. Kozawa, R. H. Brodd, Proc. Manganese Dioxide Symp., vol. 1, IC Sample Office, Cleveland, Ohio, 1975), support strongly the development of advanced Li ion secondary battery. Lithium and lithium alloys have been suggested as negative electrodes for lithium battery because lithium is a highly reactive material and lithium and its alloys have low atomic weights. Lithium and lithium alloys have many desirable characteristics as anode materials. However, the following issues still limited their practical uses.

Lithium is highly reactive and readily reacts with numbers of organic solvents. Such reactions in a battery environment may result in an undesirable self-discharge and consequently the solvents that react with lithium cannot typically be used to dissolve appropriate lithium salts to form electrolyte. It has been suggested to overcome this problem by alloying lithium with a less reactive metal such as aluminum. The presence of high content of aluminum lowers the reactivity of the lithium, but it also increases the weight of the anode (the density of aluminum more than five times the density of lithium) and the electric potential of Li—Al alloy electrodes will increase about 0.3 volt (Rao. et al., U.S. Pat. No. 4,002,492, 1977; U.S. Pat. No. 4,056,885, 1977; B. M. L. Rao, R. W. Francis and H. A. Christopher, Journal of the Electrochemical Society, 1977, 124 (10): 1490-1492; J. O. Besenhard, Journal of Electroanalytical Chemistry, 1978, 94 (1): 77-81; Lai et al., U.S. Pat. No. 4,048,395, 1977; M. Ishikawa, K. Y. Otani, M. Morita and Y. Matsuda, Electrochimica Acta, 1996, 41 (7-8): 1253-1258). From an electrochemical point of view, some alloys have the advantage as an anode, for example LiAl, but it is perceived as too fragile and brittle to be used as the cycle numbers of electrode increase (Belanger et al., U.S. Pat. No. 4,652,506, 1987; N. Yevgeniy S, U.S. Pat. No. 6,955,866B2, 2005; Bhaskara. M. L. Rao, U.S. Pat. No. 4,002,492, 1977; Bhaskara. M. L. Rao, U.S. Pat. No. 4,056,885, 1977). However, a small amount of AlI₃ can be added into electrolyte to form Li—Al alloy, and the cycling performance of battery can be improved (Masashi Ishikawa, et al., Journal of Power Sources 146 (2005) 199-203; D. Aurbachm, et al., Journal of The Electrochemical Society, 149 (10) A1267-A1277 (2002); M. Ishikawa, S. Machino and M. Morita, Journal of Electroanalytical Chemistry, 1999, 473 (1-2): 279-284; D. Fauteux and R. Koksbang, Journal of Applied Electrochemistry, 1993, 23 (1): 1-10).

Metallic Li is reacted with electrolyte, water and organic solvent to form solid electrolyte intermediate phase (SEI) (Pled, E. J. Electrochem. Soc. 1979, 126, 2047), which makes current distribution non-uniform, causing “dendritic lithium” to form during recharging of metallic lithium. Such “dendritic lithium” can easily penetrate into the separator to contact with the opposing electrode and cause internal short, which results in heat generation and contingent ignition. At the same time, part of the deposited lithium may become electronically isolated, and then shed into electrolyte to form “dead lithium”. Such “dead lithium” not only decreases cycling efficiency but also acts as an active site for reductive decomposition of electrolyte components, leading to a threat to safety (J. O. Besenhard, G. Eichinger, J. Electroanal. Chem. 68 (1976)1; J. O. Besenhard, J. Gürtler, P. Komenda, A. Paxinos, J. Power Sources 20 (1987) 253; D. Aurbach, Y. Gofer, Y. Langzam, J. Electrochem. Soc. 136 (1989) 3198; K. Kanamura, H. Tamura, Z. Takehara, J. Electroanal. Chem. 333 (1992) 127).

Many modification attempts have been tried in order to restrain the dendrite growth and improve the cycling efficiency of the lithium in liquid electrolyte, including various chemical and physical modifications by different kinds of inorganic or organic materials. The inorganic modification includes in-situ forming a protective film on lithium surface and sandwiching inorganic septum between electrolytes. The former is mainly formed by adding different additives to react with lithium, such as:

CO₂ (Hong Gan and Esther S. Takeuchi, Journal of Power Sources 62 (1996) 45), N₂O (J. O. Besenhard, M. W. Wagner, M. Winter, A. D, J. Power Sources 44 (1993) 413);

HF (K. Kanamura, S. Shiraishi, Z. Takehara, J. Electrochem. Soc. 141 (1994) L108; K. Kanamura, S. Shiraishi, Z. Takehara, J. Electrochem. Soc. 143 (1996) 2187; S. Shiraishi, K. Kanamura, Z. Takehara, Langmuir 13 (1997) 3542; [23] Z. Takehara, J. Power Sources 68 (1997) 82);

AlI₃, SnI₂ (Y. S. Fung and H. C. Lai, J. Appl. Electrochem. 22 (1992) 255; J. O. Besenhard, J. Yang, M. Winter, J. Power Sources 68 (1997) 87; M. Ishikawa, M. Morita, Y. Matsuda, J. Power Sources 68 (1997) 501);

MgI₂ (C R CHAKRAVORTY, Bull. Mater. Sci., 17 (1994) 733; Masashi Ishikawa, et al., Journal of Electroanalytical Chemistry, 473 (1999) 279; Masashi Ishikawa, et al., Journal of Power Sources 146 (2005) 199-203); etc.

However, these films generally have a porous appearance, through which the electrolyte can penetrate, and cannot completely affect protection. The latter is direct-forming protective films of various Li-induced ions on Li surface by various physical methods such as sputtering of C₆₀ (A. A. Arie, J. O. Song, B. W. Cho, J. K. Lee, J Electroceram 10 (2008) 1007), LiPON, LiSCON (Bates. et al., U.S. Pat. No. 5,314,765 1994 May; U.S. Pat. No. 5,338,625 1994 August; U.S. Pat. No. 5,512,147 1996 April; U.S. Pat. No. 5,567,210 1996 October; U.S. Pat. No. 5,597,660 1997 January; Chu. et al., U.S. Pat. No. 6,723,140B2 2004 April; Visco. et al., U.S. Pat. No. 6,025,094 2000 February; U.S. Pat. No. 7,432,017B2 2008 October; De Jonghe L, Visco S J, et al., US 2008113261-A1) and the like on the lithium anode surface, but the operation conditions need to be controlled strictly, and the production cost is increased as well, which is not beneficial for preparation in large amounts or for commercial applications.

The organic modification can be done by two methods: (a) To make a pre-formed protective layer on lithium anode surface such as poly-2-vinylpyridine, poly-2-ethylene oxide (PEO) (C. Liebenow, K. Luhder, J. Appl. Electrochem. 26 (1996) 689; J. S. Sakamoto, F. Wudl, B. Dunn, Solid State Ionics 144 (2001) 295), polyvinyl pyridine polymer, two vinyl pyridine polymer (Mead et al., U.S. Pat. No. 3,957,533 1976 May; N. J. Dudneyr, J. Power Sources 89 (2000) 176), and (b) To form a protective coating by the in-situ reactions between different additives and lithium anode. The additives include 2-methylfuran, 2-methylthiophene (M. Morita J. Ekctrochimica Acta 31 (1992) 119) and quinoneimine dyes, etc. (Shin-Ichi Tobishim, Takeshi Okada, J. of Appl. Electrochem. 15 (1985) 901), vinylene carbonate (Hitoshi Ota. et al., J. Electrochimica Acta 49 (2004) 565). The defects thereof are similar to those of the above inorganic modification method.

The process of physical modification is complicated, including control of pressure on the Li anode and temperature of the reaction systems to treat electrolyte (Toshio Hirai, et al., J Electrochem. Soc. 141 (1994) 611; Masashi Ishikawa, et al., Journal of Power Sources 81-82 (1999) 217). As known from the modification effects on metallic Li surface mentioned above, the above problems cannot be completely solved. Currently, it is rare to combine organic and inorganic modifications on lithium anode.

No matter which way of in-situ or ex-situ techniques is used to prepare Li electrode having protective layer, a smooth and neat lithium electrode surface for the protective layer deposition is desired. However, most commercial lithium bulk has a rough surface, which may result in an inhomogeneous lithium surface by deposition.

All the metallic lithium electrodes must be prepared under conditions without oxygen, carbon dioxide, water and nitrogen because of their high reactivity. So it becomes more difficult to make a dense lithium anode with reasonable cost.

Because of the above reasons, how to find out an effective technique to make a protective layer on lithium anode surface has become a key point to develop lithium battery with high specific energy density.

However, up to the present, there is not developed in the art an effective metallic Li anode protection technology that can lower Li-electrolyte interface resistance to make the interface stable, and can increase cycle efficiency of metallic Li and extend cycle life of battery.

Therefore, there is an urgent need in the art for an effective metallic Li anode protection technology, which can lower Li-electrolyte interface resistance to make the interface stable, and can increase cycle efficiency of metallic Li and extend cycle life of battery.

### SUMMARY

The disclosure provides a novel protected metal anode architecture and method of making the same, which has overcome the shortcomings of the prior art.

In one embodiment, the present disclosure provides a protected metal anode architecture comprising: a metal anode; and a composite protection film formed over and in direct contact with the metal anode, wherein the metal anode comprises a metal selected from the group consisting of an alkaline metal and an alkaline earth metal, and the composite protection film comprises particles of an inorganic compound dispersed throughout a matrix of an organic compound.

In an embodiment, the metal anode comprises lithium metal or a lithium metal alloy.

In another embodiment, the inorganic compound comprises a reaction product of lithium metal and a compound or salt containing one or more elements selected from the group consisting of Al, Mg, Fe, Sn, Si, B, Cd, and Sb.

In another embodiment, the organic compound comprises one or more of an alkylated pyrrolidine, phenyl pyrrolidine, alkenyl pyrrolidine, hydroxyl pyrrolidine, carbonyl pyrrolidine, carboxyl pyrrolidine, nitrosylated pyrrolidine and acyl pyrrolidine.

In another embodiment, the metal anode comprises lithium metal, the inorganic compound comprises a LiAl alloy, and the organic protection film comprises lithium pyrrolidine.

In another embodiment, the organic compound is formed as a reaction product of the metal anode and an electron donor compound and the inorganic compound is formed as a reaction product of the metal anode and a metal salt.

In another embodiment, the electron donor compound is selected from the group consisting of pyrrole, indole, carbazole, 2-acetylpyrrole, 2,5-dimethylpyrrole and thiophene.

In another embodiment, the composite protection film has an average thickness of from 200 to 400 nm.

In another embodiment, the inorganic particles are inhomogeneously dispersed throughout the matrix.

In another embodiment, a concentration of the inorganic particles in the matrix decreases with a distance from the metal anode.

The disclosure further relates to a method of forming a protected metal anode architecture comprising: optionally pre-treating an exposed surface of a metal anode; exposing the metal anode to a solution comprising a metal salt and an electron donor compound; and forming a composite protection film over the metal anode, the composite protection film comprising particles of an inorganic compound dispersed throughout a matrix of an organic compound, wherein the inorganic compound is formed as a reaction product of the metal salt and the metal anode, and the organic compound is formed as a reaction product of the electron donor compound and the metal anode.

In a related embodiment, the pre-treating comprises exposing the metal anode to a solution comprising one or more inactive additives selected from the group consisting of tetrahydrofuran, di-methyl ether, di-methyl sulfide, acetone and diethyl ketone.

In another embodiment, the metal salt is aluminum chloride.

In another embodiment, a concentration of the metal salt in the solution is from 0.005 to 10M.

In another embodiment, the electron donor compound is selected from the group consisting of pyrrole, indole, carbazole, 2-acetylpyrrole, 2,5-dimethylpyrrole and thiophene.

In another embodiment, a concentration of the electron donor compound in the solution ranges from about 0.005 to 10M.

In another embodiment, a concentration of the electron donor compound in the solution is from 0.01 to 1M.

In another embodiment, during exposure a pH of the solution is from 6 to 9.

In another embodiment, during the exposure a temperature of the solution is from −20° C. to 60° C.

In another embodiment, the reaction products are formed by applying a current density of from 0.1 to 5 mA/cm² and a charge potential of from 1 to 2V between the metal anode and a second electrode.

In another embodiment, the reaction products are formed by applying a current density of from 1 to 2 mA/cm² and a charge potential of from 1 to 2V between the metal anode and a second electrode.

### BRIEF DESCRIPTION OF THE DRAWINGS

FIG. 1 illustrates the principle of forming metallic lithium electrode material modified by metal Al-pyrrole composite;

FIG. 2 illustrates impedance spectra as a function of time for a lithium battery (Li/LiPF₆+EC+DMC/Li) fabricated according to Example 1;

FIG. 3 illustrates impedance spectra as a function of time for a lithium battery (Li/AlCl₃(0.1M)+Pyrrole(0.1M)+LiPF₆+EC+DMC/Li) fabricated according to Example 6;

FIG. 4 illustrates cycling efficiency of lithium in batteries with Cu/AlCl₃(0.1M)+Pyrrole(0.1M)+LiPF₆+EC+DMC/Li after 20 cycles according to one embodiment;

FIG. 5 illustrates EDS of deposited lithium surface in batteries with Cu/AlCl₃(0.1M)+Pyrrole(0.1M)+LiPF₆+EC+DMC/Li after 20 cycles according to one embodiment;

FIG. 6 illustrates SEM graph of the lithium anode surface in batteries with Cu/LiPF₆+EC+DMC/Li after 50 cycles according to one embodiment;

FIG. 7 illustrates SEM graph of the lithium anode surface in batteries with Cu/AlCl₃(0.1M)+Pyrrole(0.1M)+LiPF₆+EC+DMC/Li after 50 cycles according to one embodiment; and

FIG. 8 illustrates SEM graph of the lithium anode surface in batteries with Cu/AlCl₃(0.1M)+Pyrrole(0.1M)+LiPF₆+EC+DMC/Li after 100 cycles according to one embodiment.

### DETAILED DESCRIPTION

After extensive and intensive study, the present inventors, directed at problems such as the growth of “dendritic lithium” during cycling process and low cycling efficiency, utilize the reaction of Li and pyrrole in the electrolyte to form a layer of lithiated pyrrole organic protective film, and meanwhile, utilize metallic Li to reduce metal Al ions to form a layer of Li—Al alloy protective layer, thus providing a new method of protecting metallic Li electrode surface.

In one embodiment, disclosed is a metal electrode material having a composite protective film, wherein the metal electrode includes an alkali metal or alkaline earth metal electrode, and an organic-inorganic anode protective layer is formed on the surface of metal electrode by in-situ electrochemical reaction or ex-situ chemical reaction, wherein the inorganic protective layer is a metal alloy protective layer, and the organic protective layer is a reaction product of metal salt and electron donor.

The composite protective film may include two layers, wherein one layer is an inorganic Li—Al alloy protective film, and the other layer is lithiated pyrrole organic film.

The alkali metal or alkaline earth metal electrode materials may include Li, Na, K, Mg, etc.

In embodiments, the inorganic Li—Al alloy protective film (i) can be obtained by reducing the lithium, and the organic product that is obtained by competing reaction can effectively solve the problem of volume expansion of alloy produced as cycling number increases, and can improve the cycling life of the battery, and (ii) can be formed by electrodeposition, which not only lowers the surface reactivity of metallic Li, but also improves cycling efficiency of metallic Li, and can be easily prepared. This kind of protective film can also be extended to other kinds of Li alloy protective layers, such as Li—Mg, Li—Al—Mg, Li—Fe, Li—Sn, Li—Si and Li—B.

The lithiated pyrrole organic film (i) can be used as an electron donating compound, and form a protective layer by physically adsorbed on surface of a metallic Li anode; and (ii) can be chemically reacted with metallic Li to obtain a protective film. This kind of protective film can be extended to another kinds of electron donating compounds such as indole, carbazole, 2-acetylpyrrole, 2,5-dimethylpyrrole, thiophene and pyridine.

In embodiment, the lithiated pyrrole organic film is an assembled membrane, since the pyrrole anion has a high selectivity for Li ion, which not only has strong capacity for capturing Li ion, but also has a strong exclusion to the other components of the electrolyte or impurities, and meanwhile, it has a certain reducing ability.

The organic protective layer can be obtained by directly reacting metallic Li and pyrrole in chemical or electrochemical reaction. Further, to avoid H₂ generation, the reaction is performed in neutral or weak basic environment (pH=7-8).

To stabilize the pyrrolidine anion and to avoid H₂ generation, the surface of metallic Li electrode can be washed by tetrahydrofuran (THF). This kind of washing agent can be extended to another kind of inactive organic compounds such as nonpolar ethers (for example, dimethyl ether, dimethyl sulfide, etc.), and ketones (for example, acetone, diethyl ketone and the like).

The thickness of the composite protective film can depend on the concentration of metal salt such as AlCl₃ and the concentration of electron donor such as pyrrole. The higher the concentration of both, the thicker the film, but the thickness of each layer is generally no more than 200 nm.

In general, the thicker the inorganic Li—Al alloy protective film, the higher the cycling efficiency of the metallic Li, but the interface resistance changes less. The thicker the lithiated pyrrole organic film, the lower the Li-electrolyte interface resistance, but the cycling efficiency is greatly lowered. To keep low interface resistance and high cycling efficiency, the suitable doping concentration range for AlCl₃ and pyrrole is 0.01-1M, wherein the best ratio is 0.1M of AlCl₃ to 0.1M of pyrrole.

The density of the composite protective film can be in the range of 20-95% of its theoretical density, in embodiments not less than 60%.

The suitable temperature range for preparing composite protective film by in-situ or ex-situ reaction is −20° C. to 60° C., such as 25° C.

For ex-situ chemical reaction, the thickness of a composite protective film is related to the reaction time between lithium and pyrrole as well as the concentration of pyrrole. For all concentrations of pyrrole, an example reaction time is 2-3 min.

The thickness of inorganic Li—Al alloy protective film obtained by inorganic ex-situ chemical reaction can depend on the concentration of AlCl₃. The thickness of a composite protective film fabricated by in-situ electrochemical method also depends on the current density and charge potential, wherein an example current density is 0.5-2 mA/cm², and an example charge potential is 1-2V.

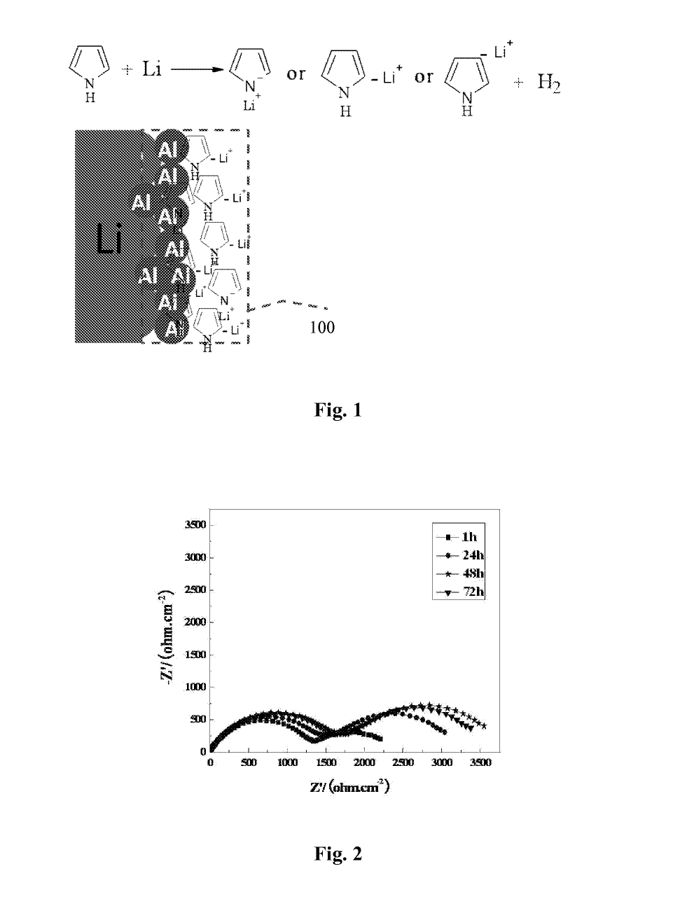

In a further embodiment, disclosed is a method of manufacturing Al-pyrrole composite modified lithium anode (See FIG. 1, which shows an Al-pyrrole composite protective layer 100) and the representation of its electrochemical properties. The method is shown as following:
(1) Formulating different concentrations (0.1-1M) of pyrrole and electrolyte (for example, 1M LiPF₆/(EC+DMC) (w/w 1:1)) according to a stoichiometric ratio in the dark;
(2) Weighting different mass of AlCl₃ according to a stoichiometric ratio, and formulating a mixed solution of different AlCl₃ (0.1-1M)-pyrrole (0.1-1M)-electrolyte (for example, 1M LiPF₆/(EC+DMC) (w/w 1:1)) with the above (1);
(3) Using two fresh lithium foils as lithium electrodes with a diameter of 14 mm and a thickness of 1-2 mm, the above mixed solution in the above (2) as electrolyte, and polypropylene film (obtained from Celgard, US) as a separator, to assembly 2025 coin-type symmetrical cells; after standing for 1-72 h, taking an electrochemical AC impedance test for different hours;
(4) Under inert environment or vacuum, using Cu electrodes as working electrodes with a diameter of 14 mm and a thickness of 1-2 mm and pre-polished to a mirror surface, the other conditions being the same as those of (3), to assembly a cell; after standing for 24 h, conducting galvano-static charge/discharge tests.

### Representation of Morphology of the Products

Scanning Electron Microscopy (SEM) is applied to observe the morphology of deposited lithium and Li electrode surface after different galvano-static charge/discharge cycling tests. Energy Disperse Spectrum (EDS) is applied for elemental analysis of the surface of deposited lithium.

After tests, the obtained Al-pyrrole coated Li electrode has a lower and more stable interface resistance, a layer of transparent protection film is formed on the Li electrode surface, the cycling efficiency of deposited lithium, Li is uniformly deposited in the form of fiber, and floccose Al particles are deposited in the Li gap.

Advantages of the disclosed approach include: In the composite protective film disclosed herein, firstly, inorganic Li—Al alloy protective film can not only effectively lower reactivity of the metallic Li electrode to stabilize the lithium anode-electrolyte interface, but can also effectively suppress the growth of dendrite to increase the cycling efficiency of Li; meanwhile, during the reaction of Li and pyrrole, organic product (lithiated pyrrole) can buffer the volume expansion of the Li—Al alloy during the cycling process so as to improve the cycling life of the battery; and, as compared with the preparation process for solid state Li—Al alloy electrode, the process can be easily conducted and is easy for commercial application; secondly, the lithiated pyrrole organic film is a self-assembled protective film having a high electronic conductivity and a certain lithium ion conductivity, which can reduce the interface resistance at the lithium-electrolyte interface, and the interface resistance thereof does not increase over time; such a film is not sensitive to water or air, and since the pyrrole anion has strong a selectivity to lithium ions, adverse reaction between Li and the electrolyte component can be avoided; thirdly, the use of THF to pre-treat the Li surface can minimize gas generation and stabilize the pyrrole anion. Such a composite film can more effectively protect Li electrode and avoid the generation of side reaction.

### EXAMPLES

The disclosure is to be illustrated in more details with reference to the following specific examples. However, it is to be appreciated that these examples are merely intended to exemplify the disclosure without limiting its scope in any way. In the following examples, if no conditions are denoted for any given testing process, either conventional conditions or conditions advised by manufacturers should be followed. All percentages and parts are based on weight unless otherwise indicated.

### Example 1

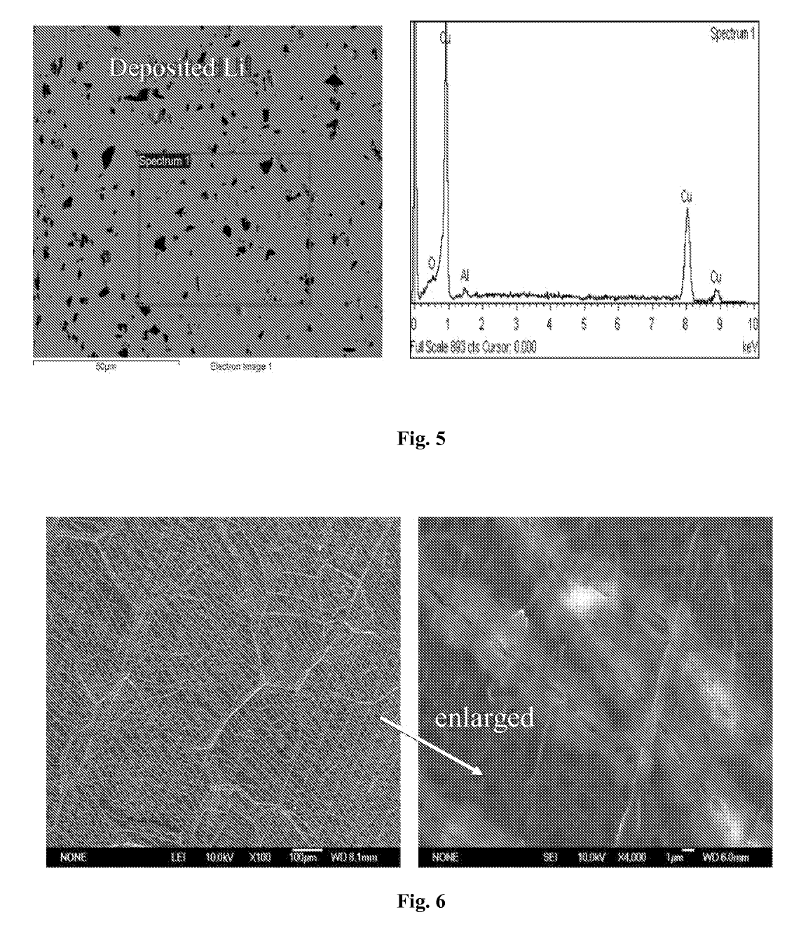

Using lithium foil as lithium electrodes with a diameter of 14 mm and thickness of 1-2 mm, polypropylene film (obtained from Celgard, US) as separator, and electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1 (See also FIGS. 2 and 6).

### Example 2

Using lithium foil as lithium electrodes with a diameter of 14 mm and thickness of 1-2 mm, polypropylene film (obtained from Celgard, US) as separator, and pyrrole (0.1M)/electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1.

### Example 3

Using lithium foil as lithium electrodes with a diameter of 14 mm and thickness of 1-2 mm, polypropylene film (obtained from Celgard, US) as separator, and pyrrole (0.5M)/electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1.

### Example 4

Using lithium foil as lithium electrodes with a diameter of 14 mm and thickness of 1-2 mm, polypropylene film (obtained from Celgard, US) as separator, and AlCl₃ (0.01M)+pyrrole (0.1M)/electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1.

### Example 5

Using lithium foil as lithium electrodes with a diameter of 14 mm and thickness of 1-2 mm, polypropylene film (obtained from Celgard, US) as separator, and AlCl₃ (0.05M)+pyrrole (0.1M)/electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1.

### Example 6

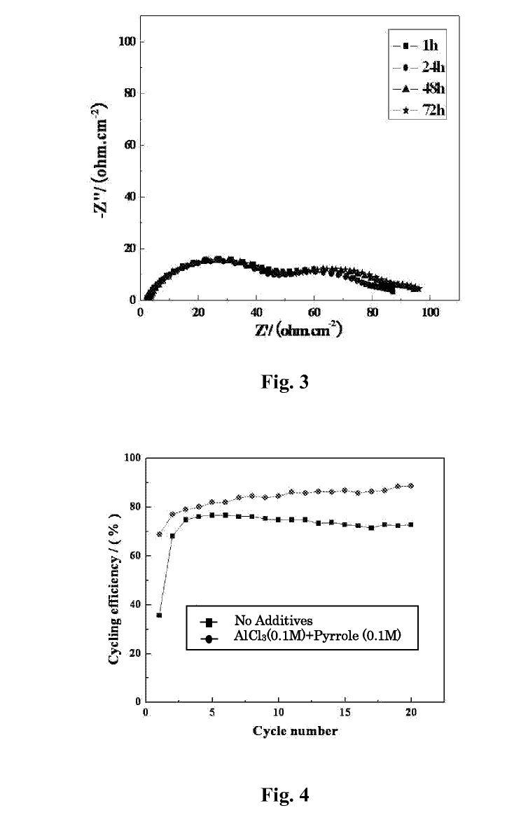

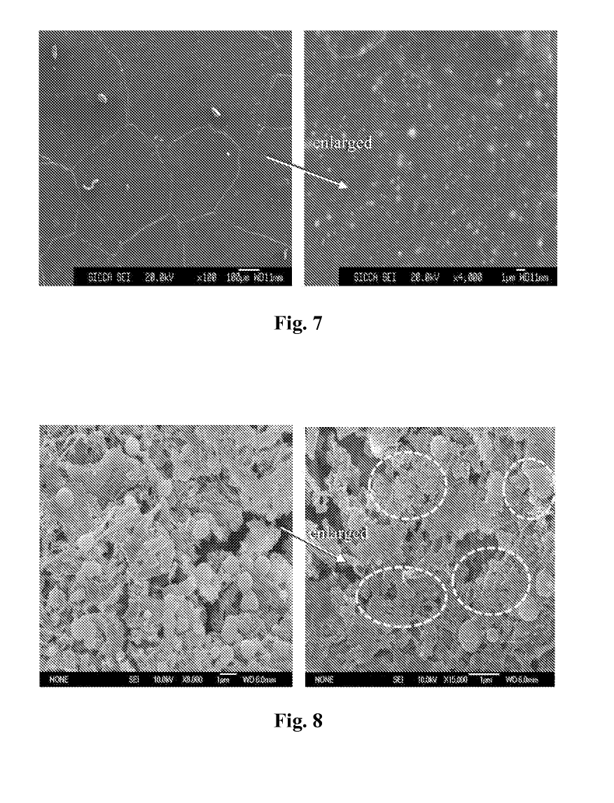

Using lithium foil as lithium electrodes with a diameter of 14 mm and thickness of 1-2 mm, polypropylene film (obtained from Celgard, US) as separator, and AlCl₃ (0.1M)+pyrrole (0.1M)/electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1 (See also FIGS. 3-5 and 7-8).

### Example 7

Using lithium foil as lithium electrodes with a diameter of 14 mm and thickness of 1-2 mm, polypropylene film (obtained from Celgard, US) as separator, and AlCl₃ (0.1M)+pyrrole (0.5M)/electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1.

### Example 8

Using lithium foil as lithium electrodes with a diameter of 14 mm and thickness of 1-2 mm, polypropylene film (obtained from Celgard, US) as separator, and AlCl₃ (0.1M)+pyrrole (1M)/electrolyte (1M LiPF₆/(EC+DMC) (w/w 1:1)) mixed solution as electrolyte, to conduct test for electrochemical impedance over time at a scanning rate of 10 mV/s; then, under inert environment or vacuum, using Cu foils with the same size of lithium foils which are pre-polished to a mirror surface as working electrodes (the other conditions are not changed), to assembly cell; after standing for 24 h, taking galvanostatic charge/discharge test. The results are shown in the following Table 1.

TABLE 1

| | | | | | | Average cycling |
|---|---|---|---|---|---|---|
| | 1 h | 24 h | 48 h | 72 h | First cycling | efficiency |
| | (Ohm/ | (Ohm/ | (Ohm/ | (Ohm/ | efficiency | (the first 20 |
| | cm²) | cm²) | cm²) | cm²) | (%) | cycles) (%) |
| Unmodified | 140.663 | 317.104 | 399.333 | 433.593 | 35.7 | 74.3 |
| Li anode | | | | | | |
| 0.1M | 227.544 | 250.363 | 105.028 | 88.084 | 35.7 | 57 |
| Pyrrole | | | | | | |
| modified | | | | | | |
| 0.5M | 347.926 | 761.675 | 668.580 | 1243.130 | 18.6 | 62 |
| Pyrrole | | | | | | |
| modified | | | | | | |
| 0.01M | 42.7 | 49.1 | 49.6 | 49.8 | 28.7 | 52.8 |
| AlCl₃-0.1M | | | | | | |
| Pyrrole | | | | | | |
| modified | | | | | | |
| 0.05M | 31.8 | 39.9 | 45.6 | 49.5 | 31.3 | 70.5 |
| AlCl₃-0.1M | | | | | | |
| Pyrrole | | | | | | |
| modified | | | | | | |
| 0.1M | 36.7 | 46.2 | 42.9 | 55.5 | 68.8 | 83.6 |
| AlCl₃-0.1M | | | | | | |
| Pyrrole | | | | | | |
| modified | | | | | | |
| 0.1M | 40.5 | 36.4 | 33.4 | 32.4 | 59.8 | 73.1 |
| AlCl₃-0.5M | | | | | | |
| Pyrrole | | | | | | |
| modified | | | | | | |
| 0.1M | 39.6 | 19 | 19.6 | 18.8 | 11.1 | 58.4 |
| AlCl₃-1M | | | | | | |
| Pyrrole | | | | | | |
| modified | | | | | | |

As seen from the data listed in the above Table 1, AlCl₃ can improve cycling efficiency of Li deposition, pyrrole can lower interface resistance, so Li cycling efficiency can be increased as the concentration of AlCl₃ increases, and the interface resistance of the electrode can be decreased as the concentration of pyrrole increases. An example ratio for electrochemical properties is AlCl₃ (0.1M) to pyrrole (0.1M).

All references mentioned in this disclosure are incorporated herein by reference, as if each of them would be incorporated herein by reference independently. In addition, it is to be appreciated that various changes or modifications can be made to the disclosure by those skilled in the art who have read the content taught above. These equivalents are intended to be included in the scope defined by the following claims.

We claim:

1. A protected metal anode architecture comprising:
a metal anode; and
a composite protection film formed over and in direct contact with the metal anode, wherein:
the metal anode comprises a metal selected from the group consisting of an alkaline metal and an alkaline earth metal, and
the composite protection film comprises particles of an inorganic compound dispersed throughout a matrix of an organic compound.

2. The protected metal anode architecture according to claim 1, wherein the metal anode comprises lithium metal or a lithium metal alloy.

3. The protected metal anode architecture according to claim 1, wherein the inorganic compound comprises a reaction product of lithium metal and a compound or salt containing one or more elements selected from the group consisting of Al, Mg, Fe, Sn, Si, B, Cd, and Sb.

4. The protected metal anode architecture according to claim 1, wherein the organic compound comprises one or more of an alkylated pyrrolidine, phenyl pyrrolidine, alkenyl pyrrolidine, hydroxyl pyrrolidine, carbonyl pyrrolidine, carboxyl pyrrolidine, nitrosylated pyrrolidine and acyl pyrrolidine.

5. The protected metal anode architecture according to claim 1, wherein the metal anode comprises lithium metal, the inorganic compound comprises a LiAl alloy, and the organic protection film comprises lithium pyrrolidine.

6. The protected metal anode architecture according to claim 1, wherein the organic compound is formed as a reaction product of the metal anode and an electron donor compound and the inorganic compound is formed as a reaction product of the metal anode and a metal salt.

7. The protected metal anode architecture according to claim 6, wherein the electron donor compound is selected from the group consisting of pyrrole, indole, carbazole, 2-acetylpyrrole, 2,5-dimethylpyrrole and thiophene.

8. The protected metal anode architecture according to claim 1, wherein the composite protection film has an average thickness of from 200 to 400 nm.

9. The protected metal anode architecture according to claim 1, wherein the inorganic particles are inhomogeneously dispersed throughout the matrix.

10. The protected metal anode architecture according to claim 1, wherein a concentration of the inorganic particles in the matrix decreases with a increased distance from the metal anode.

11. A method of forming a protected metal anode architecture comprising:
optionally pre-treating an exposed surface of a metal anode;
exposing the metal anode to a solution comprising a metal salt and an electron donor compound; and
forming a composite protection film over the metal anode, the composite protection film comprising particles of an inorganic compound dispersed throughout a matrix of an organic compound, wherein
the inorganic compound is formed as a reaction product of the metal salt and the metal anode, and the organic compound is formed as a reaction product of the electron donor compound and the metal anode.

12. The method according to claim 11, wherein the pre-treating comprises exposing the metal anode to a solution comprising one or more inactive additives selected from the group consisting of tetrahydrofuran, di-methyl ether, di-methyl sulfide, acetone and diethyl ketone.

13. The method according to claim 11, wherein the metal salt is aluminum chloride.

14. The method according to claim 11, wherein a concentration of the metal salt in the solution is from 0.005 to 10M.

15. The method according to claim 11, wherein the electron donor compound is selected from the group consisting of pyrrole, indole, carbazole, 2-acetylpyrrole, 2,5-dimethylpyrrole and thiophene.

16. The method according to claim 11, wherein a concentration of the electron donor compound in the solution ranges from about 0.005 to 10M.

17. The method according to claim 11, wherein a concentration of the electron donor compound in the solution is from 0.01 to 1M.

18. The method according to claim 11, wherein during the exposure a pH of the solution is from 6 to 9.

19. The method according to claim 11, wherein during the exposure a temperature of the solution is from −20° C. to 60° C.

20. The method according to claim 11, wherein the reaction products are formed by applying a current density of from 0.1 to 5 mA/cm² and a charge potential of from 1 to 2V between the metal anode and a second electrode.

21. The method according to claim 11, wherein the reaction products are formed by applying a current density of from 1 to 2 mA/cm² and a charge potential of from 1 to 2V between the metal anode and a second electrode.
